(19) United States
(12) Patent Application Publication
(10) Pub. No.: US 2006/0198922 A1
(43) Pub. Date: Sep. 7, 2006

(54) Runner system for a plastic injection mold

(76) Inventors: Shu-Man Chiang, Tuchen City (TW); Chung-Hsin Huang, Tucheng City (TW); Kao Yi Chiu, Tuchen City (TW); Su Yu Hung, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/072,281

(22) Filed: Mar. 7, 2005

(51) Int. Cl. B29C 45/66

(52) U.S. Cl. 425/573; 425/595

(57) ABSTRACT

The present invention provides a runner system for a plastic injection mold through which molten plastic is injected into a mold cavity defined between two mold halves. The runner system includes two mold cores each of which has a slot, a clamping plate for clasping the two mold cores and combing the slots to define therebetween a runner, and a sprue extending through one of the mold halves and connecting an entrance of the runner. The clamping plate and the clasped two mold cores are embedded into the other mold half. The clamping plate defines a gate connecting an exit of the runner to said mold cavity. The clamping plate seals at least a portion of the joint formed between the two mold cores and adjacent an exit of the runner to prevent molten plastic material from flowing into the joint to form seaming lines on surfaces of molded plastic articles. Thereby, the molded plastic articles have smooth surfaces without seaming lines.

### BACKGROUND OF THE INVENTION

1. Field of the Invention

The present invention relates generally to a plastic injection mold, and more especially to a runner system for the plastic injection mold.

2. The Related Art

Nowadays, plastic articles are mostly manufactured by injection molding method. In commonly, a plastic injection mold comprises two or more mold halves and a runner system. One or more mold cavities are defined between the mold halves when they are closed together. The runner system is provided for conveying molten plastic material from a nozzle of an injection molding machine to the mold cavities. The runner system generally includes a sprue, a runner and a gate. The sprue connects the nozzle and the runner. The gate is an entrance of the mold cavity. Molten plastic material is injected into the runner from the sprue, and then flows into the mold cavity through the gate to form plastic articles.

As known by the skilled in the field, profile of the runner directly affects producing efficiency and quality of the plastic articles, and further relates to the expense of the plastic injection mold. In the field, there are many designs for profiles of the runner, for example, circular runner, half-round runner, trapezoid runner, tapered hornlike runner, etc. The tapered hornlike runner is an economical and efficient runner of the runners mentioned above. In consideration of the manufacture technique and expense, the tapered hornlike runner is usually divided into two portions and machined in two mold cores respectivly, that is, an arced tapering slot is defined in one mold core, while a mirror imaged arced tapering slot is formed in the other mold core. The two arced tapering slots are combined to define the tapered hornlike runner when the two mold cores are closed.

However, as mentioned above, the tapered hornlike runner is formed by coupling of two mold cores. One problem is that there inevitably has a joint formed between the two mold cores, and the joint directly communicates with the mold cavity. So molten plastic material injected in the mold cavity also flows into the joint, therefore a notice mark termed “seaming line” is formed on the surface of the plastic article. In any event, the appearance of such a blemish surface with a seaming line takes bad effect on the smooth of the plastic article, and such article is often unacceptable to the customer.

### SUMMARY OF THE INVENTION

In view of the above problem, an object of the present invention is to provide a runner system for a plastic injection mold to form plastic articles with smooth surface.

To obtain the above object, the present invention provides a runner system for a plastic injection mold through which molten plastic is injected into a mold cavity defined between two mold halves. The runner system includes two mold cores each of which has a slot, a clamping plate for clasping the two mold cores and combing the slots to define therebetween a runner, and a sprue extending through one of the mold halves and connecting an entrance of the runner. The clamping plate seals at least a portion of the joint formed between the two mold cores and adjacent an exit of the runner. The clamping plate and the clasped two mold cores are embedded into the other mold half. The clamping plate defines a gate connecting an exit of the runner to said mold cavity. Molten plastic is injected into said mold cavity through the sprue, the runner, and the gate.

As mentioned above, an obvious structure characteristic of the present invention is that the clamping plate covers and seals the joint between the two mold cores. Therefore, molten plastic material injected in the mold cavity is prevented from further flowing into the joint to form seaming lines on surfaces of molded plastic articles. So the molded plastic articles have smooth surfaces.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is an exploded perspective view of a plastic injection mold system including a runner system according to the present invention;

FIG. 2 is another exploded perspective view of the plastic injection mold system shown in FIG. 1;

FIG. 3 is a perspective view showing two mold cores being assembled with a clamping plate of FIG. 1;

FIG. 4 is a perspective view showing a mold half assembled with the clamping plate and one of the mold cores of FIG. 1; and

FIG. 5 is an enlarged view of a circled part that is labeled by V in FIG. 4.

### DETAILED DESCRIPTION OF THE PREFERRED EMBODIMENT

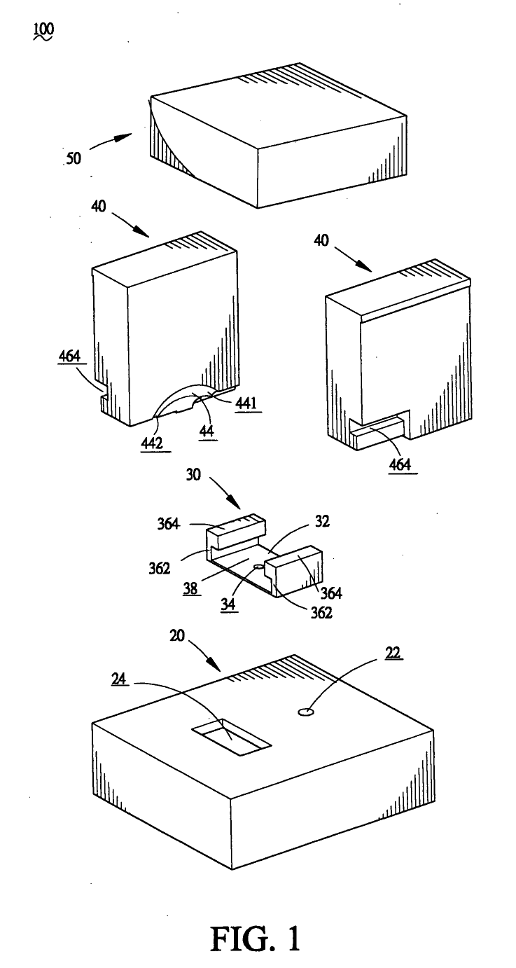

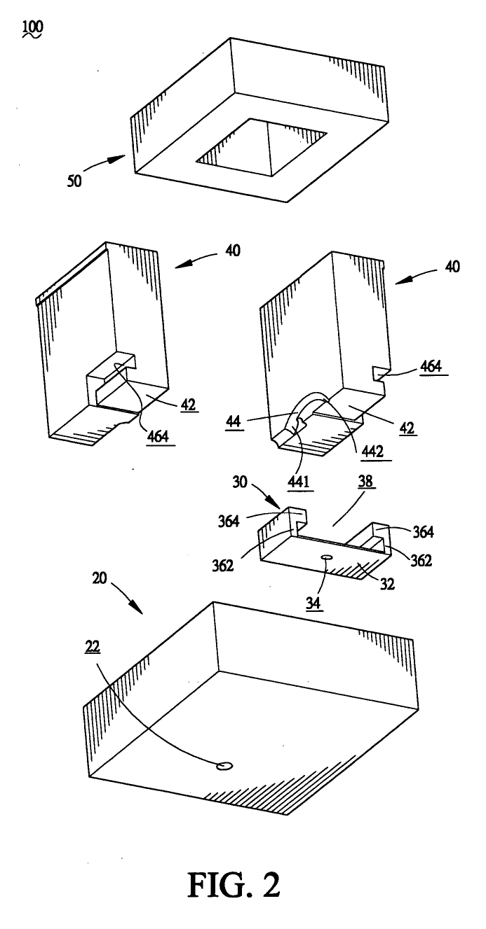

With reference to FIG. 1 and FIG. 2, a runner system for a plastic injection mold system 100 is shown. The plastic injection mold system 100 comprises a fixed mold half 20, a clamping plate 30, a pair of mold cores 40 and a moving mold half 50. The pair of mold cores 40 are assembled with the moving mold half 50 in a well-known way by the skilled in the field.

A sprue 22 extends through the fixed mold half 20 up and down. The sprue 22 connects with a nozzle of a plastic injection molding machine (not shown). A mold cavity 24 is formed when the fixed mold half 20 and the moving mold half 50 are closed. Molten plastic is injected into the mold cavity 24 to form plastic articles therein.

The clamping plate 30 is provided for clasping the two mold cores 40 together. The clamping plate 30 has a baseboard 32. A gate 34 is defined in the middle of the baseboard 32 and extends through the baseboard 32. A pair of arms 362 is extended upwardly from opposite sides of the baseboard 32 to embrace the mold cores 40. The two arms 362 and the baseboard 32 define a cavity 38 in which the mold cores 40 are partially received. Free ends of the pair of arms 362 extend horizontally and inwardly to form latch blocks 364.

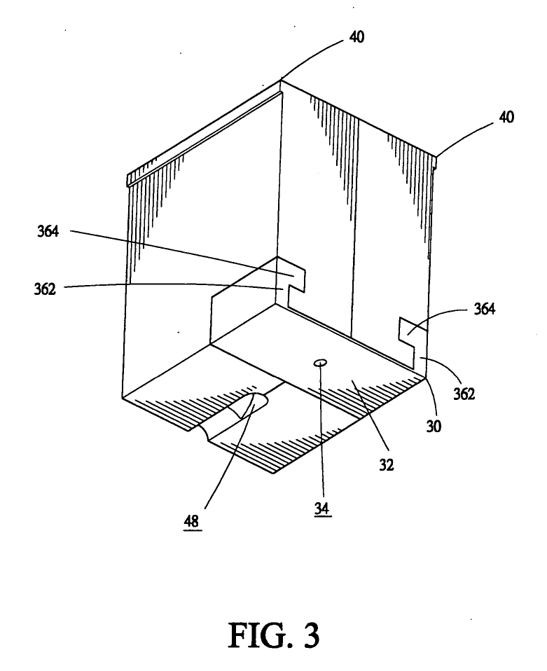

An arced tapering slot 44 is defined at an end portion of the lateral side of each mold core 40. As shown in FIG. 2, one end of the arced tapering slot 44 is a narrow opening 442, and the other end is a broad opening 441. The two arced tapering slots 44 of the mold cores 40 are combined together to define a tapered hornlike runner 48 (as shown in FIG. 3) when the two mold cores 40 are closed together. Two narrow openings 442 of the arced tapering slots 44 are combined together to define an exit of the runner 48, while two broad openings 441 are combined to define an entrance of the runner 48. Each mold core 40 further provides a groove 464 in outer side thereof to engage with the latch block 364, thus the mold cores and the clamping plate 30 are firmly assembled. The bottom surfaces of the mold cores 40 have a portion adjacent to the arced tapering slots 44 and around the grooves 464 recessed to form a recess 42 for the clamping plate 30 being embedded therein to ensure outer surface of the assembly flat.

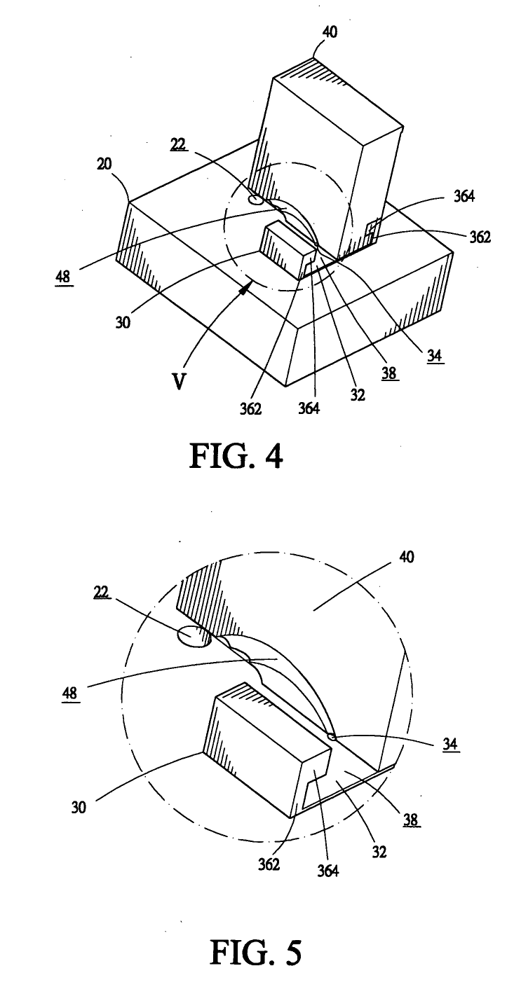

Now referring to FIG. 3 to FIG. 5, in assembling, the clamping plate 30 is embedded in the recess 42 with the arms 362 clasping the two mold cores 40 and the latch blocks 364 inserted in the grooves 464. After assembled, the clamping plate 30 seals a potion of the joint adjacent the exit of the runner 48 on the bottom surfaces of the two mold cores 40 and the gate 34 communicates with the exit of the runner 48. Then the clasped mold cores 40 together with the clamping plate 30 are embedded into the moving mold half 50. When the fixed and the moving mold halves 20, 50 are closed, the gate 34 connects the exit of the runner 48 to the mold cavity 24, and the entrance of the runner 48 communicates with the sprue 22 in the fixed mold half 20. In the process of injection molding, the molten plastic is injected into the mold cavity 24 through the sprue 22, the runner 48, and the gate 34.

As described above, in the present invention, the clamping plate 30 covers and seals the joint at the bottom surface of the two mold cores 40. The mold cavity 22 doesn't communicate with the joint. Therefore, the seaming line caused by the joint is avoided when the plastic articles are molded in the mold cavity 24.

Accordingly, there has been disclosed an improved a runner system for a plastic injection mold. While an illustrate embodiment of this invention has been disclosed herein, it is understand that various modifications and adaptations to the disclosed embodiments are possible, and it is intended that this invention be limited only by the scope of the appended claims.

What is claimed is:

1. A runner system for a plastic injection mold through which molten plastic material from a source is injected into a mold cavity, the injection mold having two mold halves, the mold cavity being defined between the two mold haves when the two mold halves are closed together, the runner system comprising:
two mold cores, each mold core having a slot;
a clamping plate for clasping the two mold cores and combing the slots to define therebetween a runner and sealing at least a portion of the joint between the two mold cores and adjacent an exit of the runner, the two clasped mold cores together with the clamping plate being embedded into one of said mold halves, the clamping plate defining a gate connecting the exit of the runner to said mold cavity; and
a sprue extending through the other mold half and connecting an entrance of the runner, the molten plastic material being injected into said mold cavity through the sprue, the runner, and the gate.

2. The runner system as claimed in claim 1, wherein said clamping plate has two arms which clasp said two mold cores together, free ends of the arms extend inwardly to form latch blocks, and said mold cores define grooves correspondingly for engaging with the latch blocks.

3. The runner system as claimed in claim 1, wherein the two clasped mold cores have a portion recessed adjacent the exit of the runner for the clamping plate being embedded therein.
